(19) United States
(12) Patent Application Publication
(10) Pub. No.: US 2013/0013457 A1
(43) Pub. Date: Jan. 10, 2013

(54) SOCIAL NETWORK INFORMATION SYSTEM AND METHOD

(76) Inventors: Darren Pulito, Moorestown, NJ (US); Lou Vastardis, Moorestown, NJ (US)

(21) Appl. No.: 13/544,198

(22) Filed: Jul. 9, 2012

Related U.S. Application Data
(60) Provisional application No. 61/505,677, filed on Jul. 8, 2011.
(60) Provisional application No. 61/539,235, filed on Sep. 26, 2011.

(51) Int. Cl. G06F 15/16; G06Q 30/00

(52) U.S. Cl. 705/26.61; 709/204

(57) ABSTRACT

The present invention is embodied in methods and system for obtaining information about a category of interest from a computer network. The method includes receiving an information request from a user, the information request specifying a category, identifying a first set of one or more users within a user network of the user, each user in the first set associated with the category and established as a trusted information resource contact of the user for the category, and identifying a second set of one or more users within a user network of one or more users of the first set, each user in the second set associated with the category and established as a trusted information resource contact of the one or more trusted information resource contacts of the first set for the category.

### CROSS-REFERENCE TO RELATED APPLICATIONS

This application claims priority to U.S. Provisional Patent Application Serial No. 61/505,677, filed Jul. 8, 2011, entitled Social Network Information Method and System and U.S. Provisional Patent Application Ser. No. 61/539,235, filed Sep. 26, 2011, entitled Social Network Information System and Method, the entireties of which are expressly incorporated herein by reference in their entireties.

### BACKGROUND OF THE INVENTION

Social networking websites such as those hosted on Facebook™ and Yahoo!™ provide network services to facilitate interaction between users. Typically, users who sign up for these services are able to establish connections with other users. As the popularity of such network services has increased many social networking websites service millions of users with many individual users having large networks including hundreds or even thousands of connections to other users.

Users of such network services may be interested in requesting information or assistance from other users with whom they have established a connection or other members in the network to which they don't have an established connection. The development of systems and methods for users of such network services to request and retrieve relevant information from other users within a social network would be useful to users.

### SUMMARY OF THE INVENTION

The present invention is embodied in methods and system for obtaining information about a category of interest from a computer network, the computer network including a plurality of user networks with each user network including a plurality of users. The network further including an electronic database of information associated with the plurality of users.

The method includes receiving an information request from a user, the information request specifying a category, identifying a first set of one or more users within a user network of the user, each user in the first set associated with the category and established as a trusted information resource contact of the user for the category, identifying a second set of one or more users within a user network of one or more users of the first set, each user in the second set associated with the category and established as a trusted information resource contact of the one or more trusted information resource contacts of the first set for the category, retrieving information associated with the one or more trusted information resource contacts of the identified second set from the electronic database corresponding to the information request, and providing the retrieved information to the user. The steps of the method may be embodied in computer executable instructions stored on a non-transient machine readable medium that cause a server to perform the method when executed by the server.

The system includes an electronic database of information and a server. The server is configured to receive an information request from a user, the information request specifying a category, identify a first set of one or more users within a user network of the user, each user in the first set associated with the category and established as a trusted information resource contact of the user for the category, identify a second set of one or more users within a user network of one or more users of the first set, each user in the second set associated with the category and established as a trusted information resource contact of the one or more trusted information resource contacts of the first set for the category, retrieve information associated with the one or more trusted information resource contacts of the identified second set from the electronic database corresponding to the information request, and provide the retrieved information to the user.

### BRIEF DESCRIPTION OF THE DRAWINGS

The invention is best understood from the following detailed description when read in connection with the accompanying drawings, in which like elements may have the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. The letter “n” may represent a non-specific number of elements. Also, lines without arrows connecting components may represent a bidirectional exchange between these components. Included in the drawings are the following figures:

FIG. 1 is a system diagram depicting an exemplary system in accordance with aspects of the present invention;

FIG. 2A is a flow chart depicting exemplary steps for establishing trustline experts from which information is retrieved in accordance with aspects of the present invention;

FIG. 2B is a flow chart depicting exemplary steps for requesting and retrieving

Information from trustline experts in accordance with aspects of the present invention;

FIG. 3 is a block diagram Illustrating the establishment of a trust-based network and the establishment of sub-network “trustline” resources within the trust-based network in accordance with aspects of the present invention;

FIG. 4 is a table depicting exemplary categories and sub-categories for use with the present invention;

FIG. 5 is a block diagram illustrating pending trustline expert requests and established trustline expert Information resources in accordance with aspects of the present invention;

FIGS. 5A, 5B, and 5C are block diagrams illustrating established trustline expert information resources of established trustline expert information resources in accordance with aspects of the present invention;

FIG. 6A is a flow chart of exemplary steps illustrating identification of product recommendations based on a shared experience in accordance with aspects of the present invention;

FIG. 6C is a flow chart of exemplary sub-steps for performing steps of the flow chart of FIG. 6B; and

FIG. 7 is an illustration of a rating scale in accordance with the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of brevity, many other elements found in typical networked applications, apparatuses, systems and methods. Those of ordinary skill in the art will thus recognize that other elements may be desirable and/or required in order to implement the present invention. However, because such elements are well known in the art, and because they do not facilitate a better understanding of the present invention, a discussion of such elements is not provided herein.

The inventors have recognized that the growing adoption within social media is creating a growing state of diminished utility for users. As the current social media products are establishing an increasing number of relationships, a state of information overload is beginning to occur. The reason is that the current social media models fail to address each user's true passions, how they learn, and why they try or buy. The inventors have further recognized that users are most strongly Influenced by small numbers of individuals with whom they have trusting interpersonal relationships. Thus, larger social circles or social networks do not translate into improved social utility. An aspect of the present invention provides a system that supports the natural human tendency for learning and changing behavior; a system that is rooted In how individual users naturally seek out trusted information resources to provide them with what they deem as valuable information. The system extends the existence of an individual user's relationship beyond their immediate circle of contacts by perpetuating “trusted” knowledge sharing category based networks extending from their existing social networks.

Embodiments of the present invention allow a user of a social network to request information from other users. The information request can include, for example, a question for dissemination to other users, a search request for information maintained in a electronic database, and/or an alert request for information once it is added to the database. Users are able to establish a select number of users as trustline experts (TSTLNs; e.g., users they trust most and/or from which they desire to receive rating information from). Additionally, the TSTLNs may be associated with one or more categories/sub-categories. Users are able to filter user generated content (UGC; such as questions and answers, reviews, ratings) from a network of extended trusted resources (e.g., other users they may view as experts) including the user's established TSTLNs, the user's established TSTLNs' TSTLNs, etc.

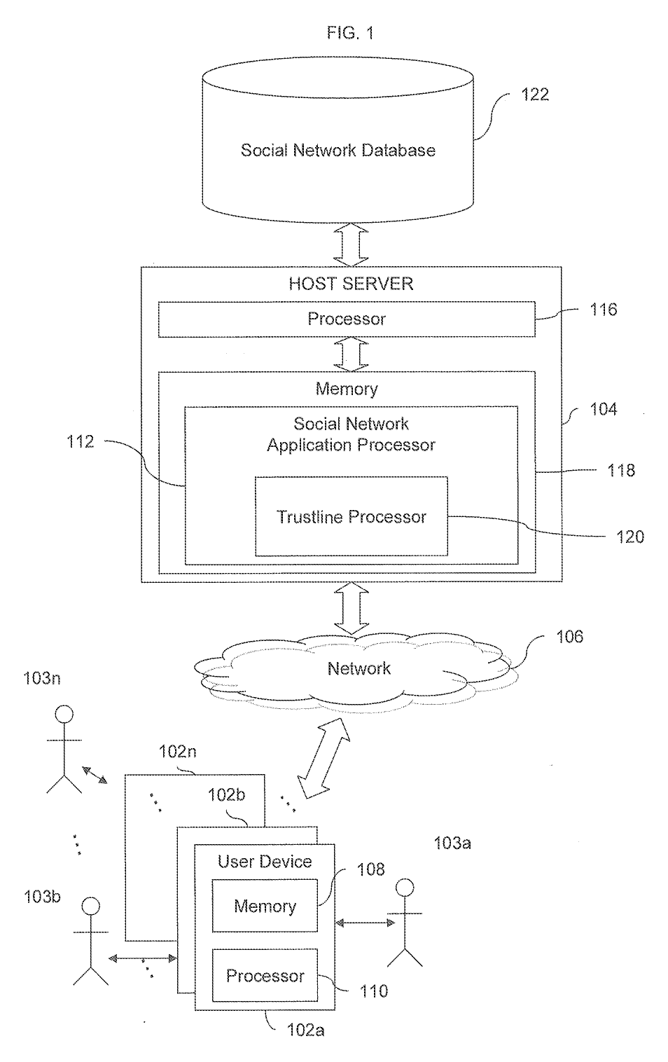

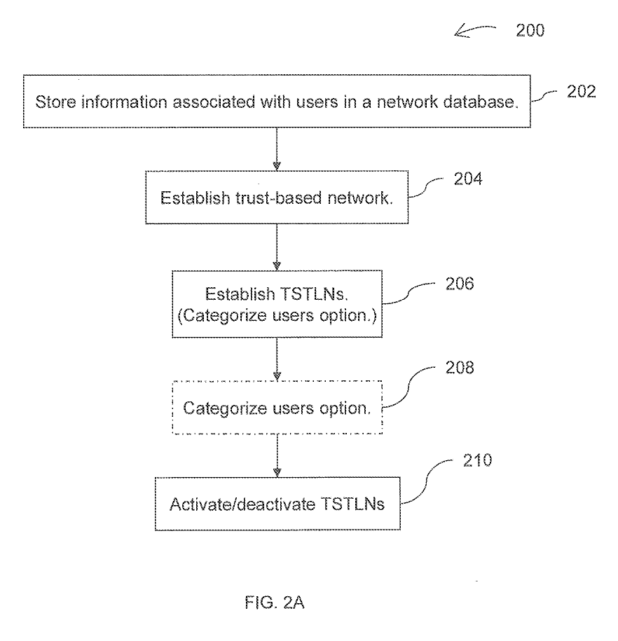

FIG. 1 is a diagram illustrating an exemplary system 100 in which exemplary embodiments of the present invention may operate. The system 100 includes multiple user devices 102a-n in communication with a host server 104 over a network 106 such as the Internet, an Intranet, a wide area network (WAN), a local area network (LAN), or other communication network capable of transporting data. Through user devices 102a-n, users 103a-n can communicate over the network 106 with each other and with other systems and devices coupled to the network 106.

Each of the user devices 102 include memory 108 and a processor 110 such as a microcontroller, microprocessor, an application specific Integrated circuit (ASIC), and/or state machine coupled to the memory 108. Memory 108 may be a conventional computer-readable medium, such as a random access memory (RAM). In an exemplary embodiment, processor 110 executes computer-executable program instructions stored in memory 108. Suitable memory 108 and processors 110 will be understood by one of skill in the art from the description herein.

User devices 102a-n may also include a number of input/output (IO) devices (not shown) such as a mouse, a CD-ROM, DVD, a keyboard, a display, or other input or output devices. Exemplary user devices 102 include personal computers, digital assistants, personal digital assistants, cellular phones, mobile phones, smart phones, pagers, digital tablets, laptop computers, Internet appliances, and processor-based devices. In general, a user device 102a may be any type of device capable of communication with a network 106 and of interaction with one or more application programs. In an exemplary embodiment, user devices 102a-n may operate on any operating system capable of supporting a browser or browser-enabled application, such as Microsoft' Windows® The user devices 102a-n shown include, for example, personal computers executing a browser application program such as Microsoft Corporation's Internet Explorer.™

The illustrated host server 104 includes a processor 116 and a memory 118. In an exemplary embodiment, processor 116 executes a social network application program (SNAP) 112 stored in memory 118. SNAP 112 allows users, such as user 103a, to interact with and participate in a computer-based social network (herein “social network”). A social network can refer to a computer network connecting users, such as people or organizations. An example of a social network in which the present invention may be implemented is Facebook™.

A social network can comprise user profiles that can be associated with other user profiles. Each user profile may represent a user and a user can be, for example, a person, an organization, a business, a corporation, a community, a fictitious person, an institution, information source, or other entity. Each profile can contain entries, and each entry can comprise information associated with a profile. Memory 118 may be a conventional computer-readable medium, such as a random access memory (RAM). In an exemplary embodiment, processor 116 executes computer-executable program instructions stored In memory 118. Suitable memory 118 will be understood by one of skill In the art from the description herein.

Host server 104, depicted as a single computer system, may be implemented as a network of computers. Examples of a host server 104 are servers, mainframe computers, networked computers, processor-based devices, and similar types of systems and devices. Processor 110 and processor 116 can be any of a number of computer processors, such as processors from Intel Corporation of Santa Clara, Calif. and Motorola Corporation of Schaumburg, Ill., which will be understood by one of skill in the art from the description herein, SNAP 112 can include a trustline processor 120. In an exemplary embodiment, processor 120 enables a user 103 to establish TSTLNs and to request information from these TSTLNs. Processor 120 may cause the display of information provided by one or more users 103 of the social network on a user device 102. Processor 120, in some embodiments, can generate, distribute, and/or update a search record. Multiple processors and other hardware can be provided to perform operations associated with embodiments of the present invention.

Host server 104 also provides access to electronic data storage elements, such as a social network storage element, e.g., electronic social network database 122, which may be stored in memory 118 of host server 104 or external to host server 104 as illustrated. The social network database 122 may be physically attached or otherwise in communication with the social network engine 112 by way of a network or other connection. The social network database 122 can be used to store users' member profiles including TSTLNs of those users. Electronic data storage elements may include any one or combination of methods for storing data, including without limitation, arrays, hash tables, lists, and pairs. Other similar types of data storage devices can be accessed by the host server 104. SNAP 112 can receive data comprising the user profiles from the social network database 122 and can also send data comprising user profiles to the social network database 122 for storage.

It should be noted that the present Invention may comprise systems having different architecture than that which is shown in FIG. 1. For example, in some systems according to the present invention, host server 104 may comprise a single physical or logical server. The system 100 shown in FIG. 1 is merely exemplary, and is used to help explain the social networks and methods described herein.

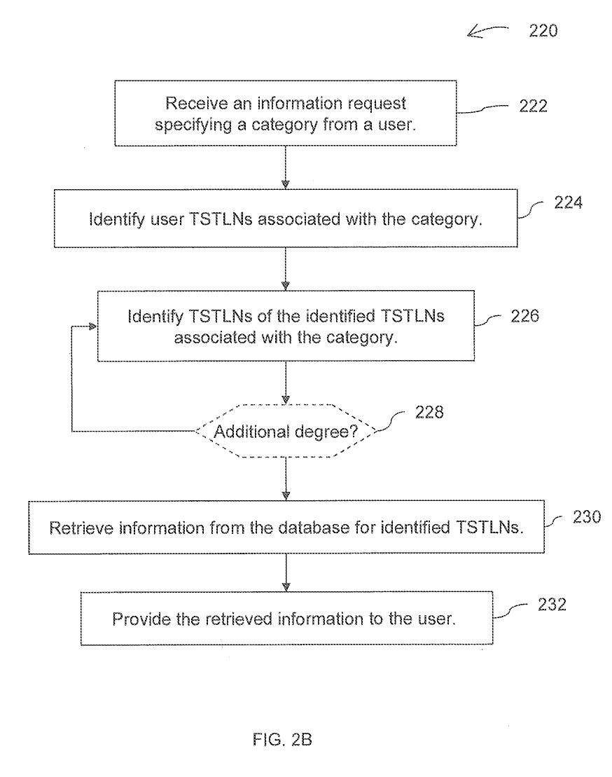

FIG. 2A depicts a flow chart 200 of exemplary steps for establishing TSTLNs from which information about a category of interest may be retrieved from a social network in accordance with aspect of the present invention. In an exemplary embodiment, the social network includes multiple user networks where each user network includes multiple users. The steps of flow chart 200 will be described with reference to the system 100 depicted In FIG. 1 to facilitate description. Other systems in which the steps of flow chart 200 may be carried out will be understood by one of skill in the art from the description herein.

At block 202, information associated with users are stored in a database. In an exemplary embodiment, information generated by users 103 may be stored in social network database 122. The information may include ratings and reviews of products, answers to questions links, or any other form of user generated content (UGC). All forms of information may be generated and stored by users of the social network prior to receiving a request for information. Additionally, information generated and stored after a request for Information may be used to satisfy a standing request.

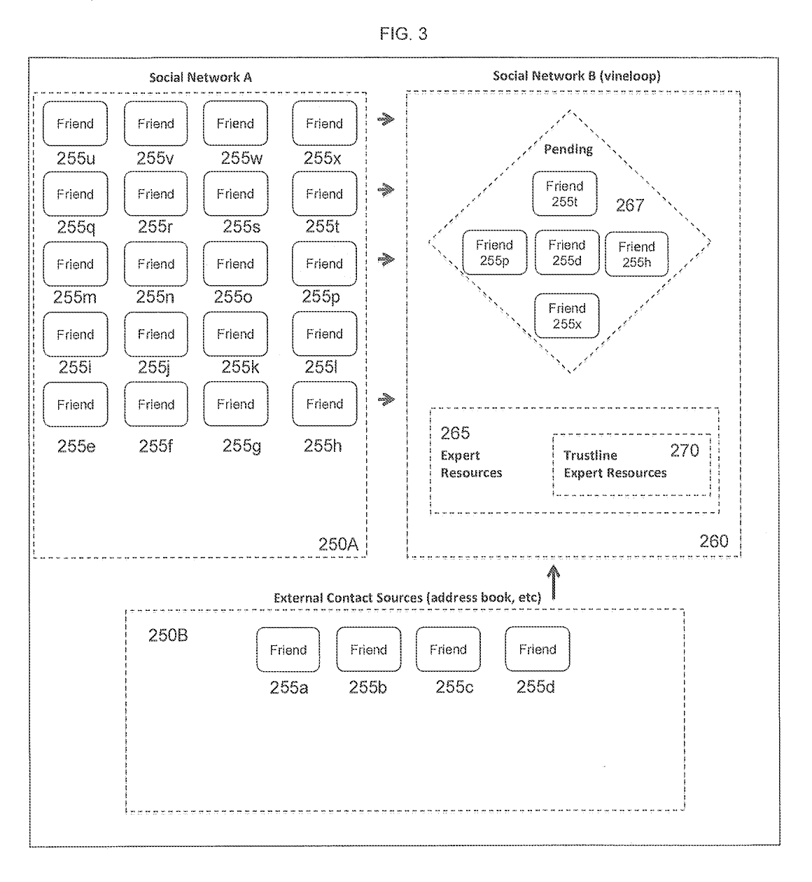

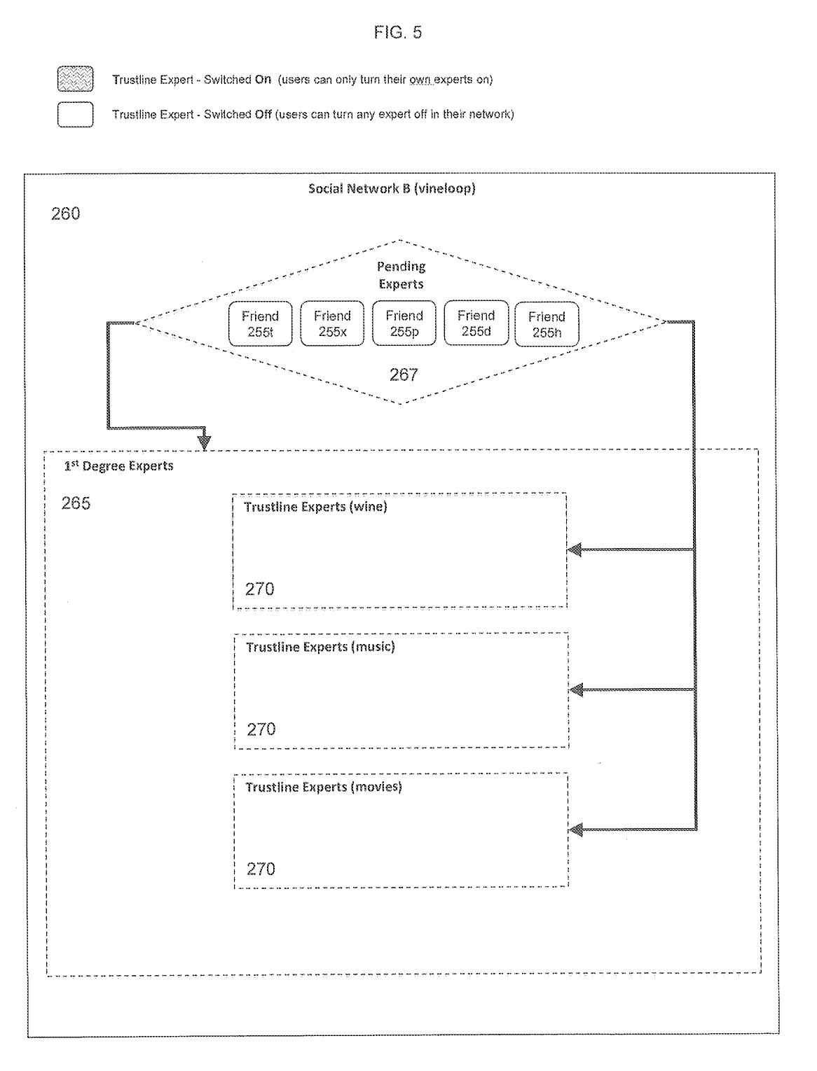

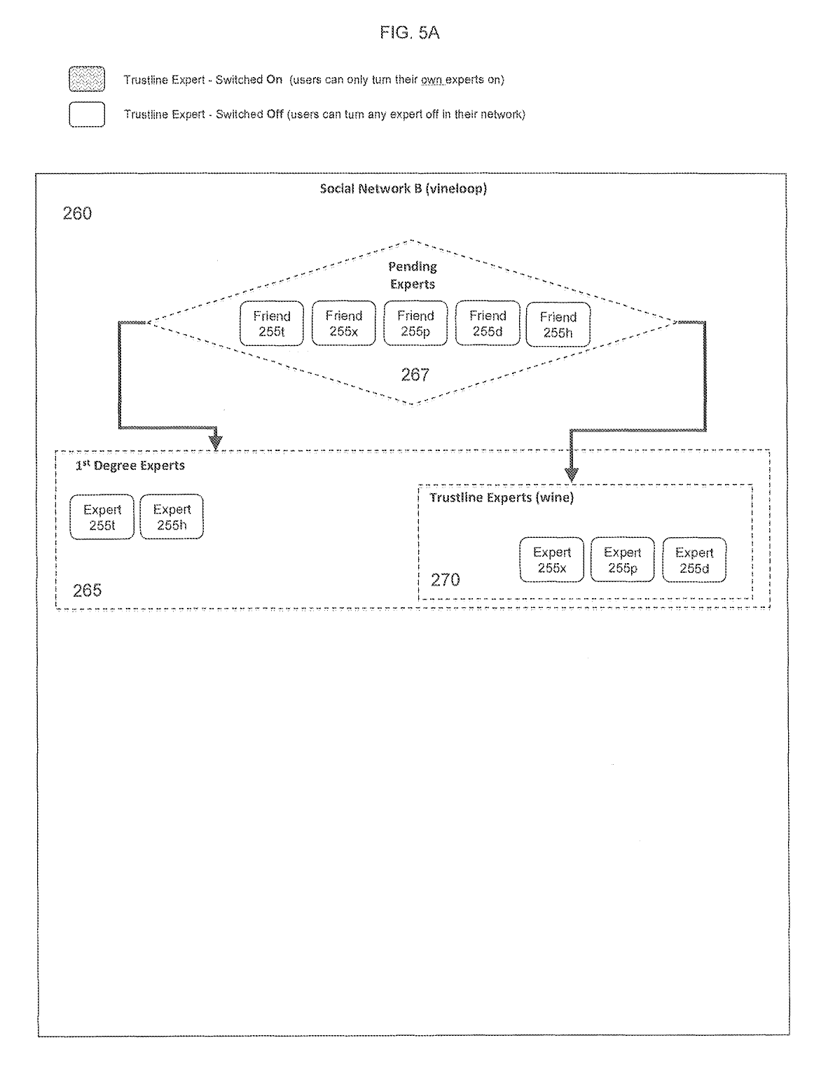

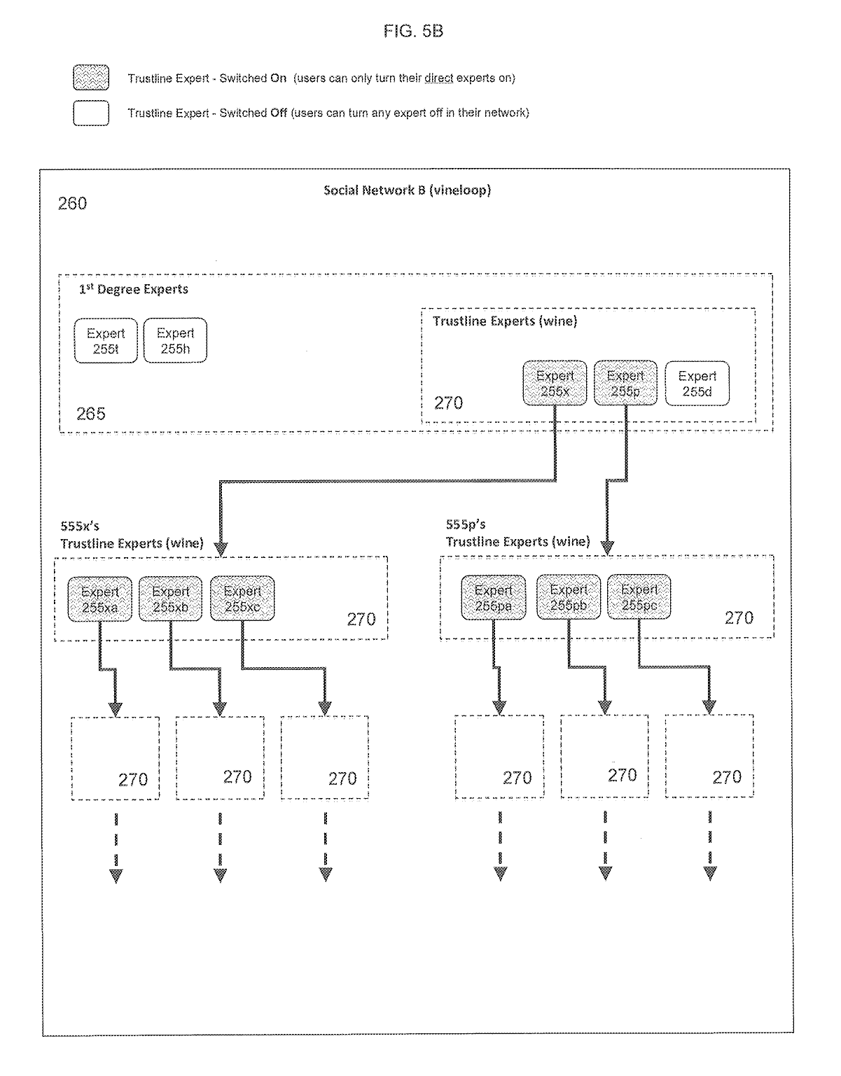

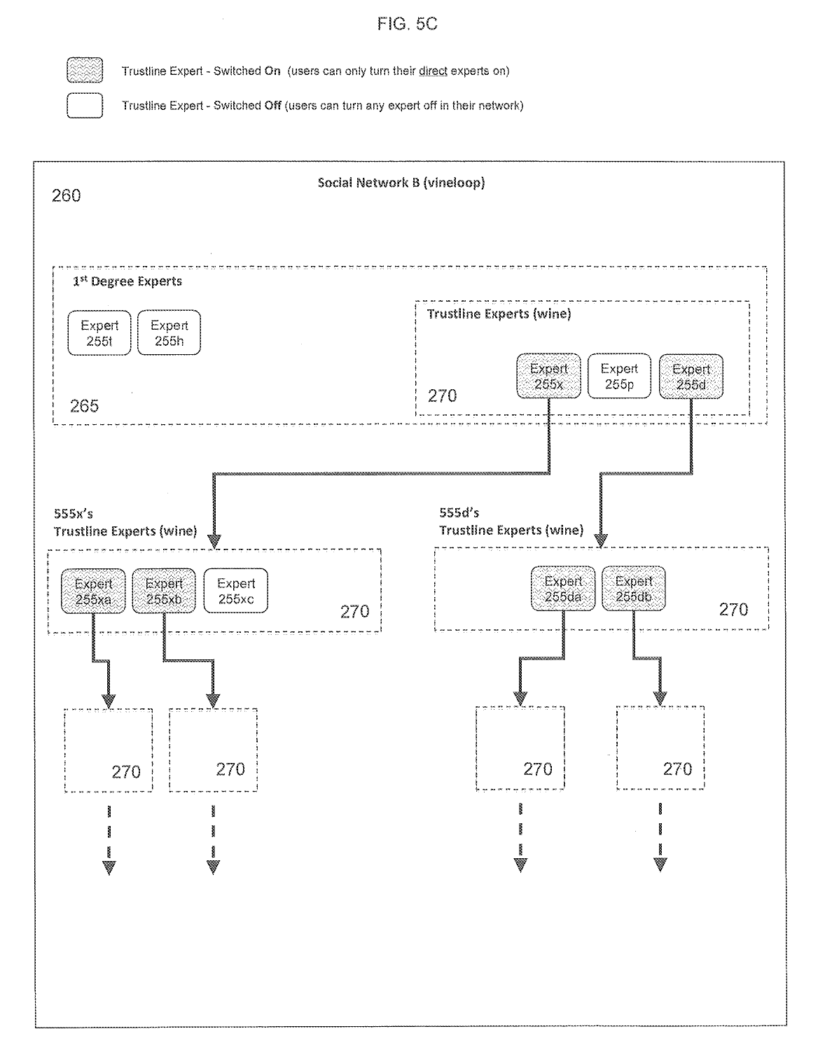

At block 204, a trust-based network is established for a user. The trust-based network may be a user's existing social network or may be formed from one or more social networks and/or external contact sources of the user including the user's contacts. FIGS. 3, 5, and 5A depict the formation of a trust-based network 260 from a user's social network 250A and external contact sources 250B of the user (e.g., an address book) including multiple contacts/friends 255a-x (24 contacts In the Illustrated embodiment). In the illustrated embodiment, contacts 255d, h, p, t, and x are contacts that the user would like to receive information from. The user may designate the contacts 255 using user device 102a by selecting the contacts 255 from the user's existing social networks and external contact sources. The trustline processor 120 may establish the trust-based network 260 and store connection information in social network database 122.

In one embodiment, the user requests that contacts 255d, h, p, t, and x become a part of the user's trusted network 260. The user may send an invitation to the contacts 255 requesting that they become a part of the user's trusted network 260. As illustrated in FIG. 5, the invitation results in the contacts having a pending status 267 within the trust-based network 260. While in a pending status 267, the user is unable to access information of the “pending” contact. Upon consent from the contacts 255 they are added to the user's trusted network 260 in a sub-network 265 of the user as illustrated in FIG. 5A (from which information may be accessed and TSTLNs may be established as described below with reference to block 206).

The invitation may be generated by user device 102a and sent to host server 104. The host server 104 then forwards the requests to the intended contacts 255d, h, p, t, and x and waits for a response. The host server 104 then adds each user from which a positive response to the invitation is received to sub-network 265. FIG. 5A depicts the establishment of a sub-network 265.

In one embodiment, the host server 104 creates a GUI for display on a user device 102. The GUI may display each contact 255 of the user along with a corresponding check box. Selection of a check box corresponding to a particular contact 255 results in an email message to that contact requesting consent. The contact may then be associated with sub-network 265 upon a positive response to the consent request. For example, referring back to FIG. 3, the user may send an invitation to five of the contacts 255 (e.g., contacts 255d, h, p, t, s) within networks 250A or 250B. The Invitation information Is received by the host server 104, which forwards invitations to the Intended contacts 255d, h, p, t, and x and waits for a response. At this point, the are pending and a information resource relationship has not been established, which is Illustrated in FIG. 5. The host server 104 then establishes each user from which a positive response to the invitation is received as a TSTLN of the user. FIG. 5A depicts the establishment of a network 265 of information resource relationships between the user and contacts 255d, h, p, t, and x.

At block 206, TSTLNs are established for a user. The TSTLNs form a sub-network 270 within sub-network 265 Including one or more contacts 255 of the user in trust-based network 260. In an embodiment, the host server 104 creates a GUI for display on a user device 102. The GUI may display each contact 255 of the user along with a corresponding check box. Selection of a check box corresponding to a particular contact 255 results in them being associated with a limited sub-network 270. FIG. 5A depicts the establishment of a network 270 of trusted Information resource relationships between the user and contacts 255x, p, and d.

In one embodiment, TSTLNs can be associated with one or more categories at the time they are established. In accordance with this embodiment, a separate step for establishing categories described below with reference to block 208 may be omitted. The user's contacts may be categorized for areas of interest such as wine, movies, restaurants, etc. In one embodiment, the user unilaterally assigns contacts 255 to one or more categories associated with limited sub-networks 270 (such as the three category based limited sub networks depicted in FIG. 5). For example, the host server 104 may create a graphical user interface (GUI) for display on a user device 102. The GUI may display each contact 255 of the user within the trust-based network 260 along with a series of check boxes corresponding to categories next to each user. The user may then simply select one or more desired categories where they wish to have the contact be a TSTLN by placing a check mark in the corresponding check box. As described below, categories may also be associated/disassociated with contacts 255 at essentially anytime.

In an embodiment, the user sends a trusted information resource request to one or more contacts 255 requesting that those contacts become TSTLNs of the user. This request may be accomplished by the invitation discussed above for the step of block 204, In which case a separate request is not necessary. In another embodiment, it may be a separate request (e.g., similar to the invitation described above with reference to block 204). Upon consent from the contacts 255 that the user may add them as TSTLNs, the contacts are added to trustline sub-network 270 as Illustrated in FIG. 5A.

At block 208, the user's contacts are categorized. Category assignments for interests such as wine, movies, restaurants can be associated/disassociated with contacts/friends within trust-based network 260. In one embodiment, the user unilaterally assign contacts 255 to one or more categories. For example, the host server 104 may create a graphical user interface (GUI) for display on a user device 102. The GUI may display each contact 255 of the user within the trust-based network 260 along with a series of check boxes corresponding to categories next to each user. The user may then simply select/remove one or more desired categories for each contact by placing/removing a check mark in the corresponding check box.

In one embodiment, categories may be associated with contacts 255 at essentially anytime. For example, categories may be associated with contacts 255 after they are established as a TSTLNs, before they are established as TSTLNs (in which case the steps of block 208 are performed prior to the steps of block 206), and/or at the time they are established as TSTLNs (in which case this step is performed as part of block 206 and block 208 may be omitted). In other embodiments, categories are not assigned. In accordance with this embodiment, the network may have a specific focus and, thus, it may not be necessary to provide additional distinction through the use of categories. For example, the network may have a focused concept (e.g., baby products) where members (e.g., parents) base their trustlines by turning on a limited number of contacts (e.g., other parents) who they trust most to provide trusted recommendations on a range of specific products (e.g., baby products).

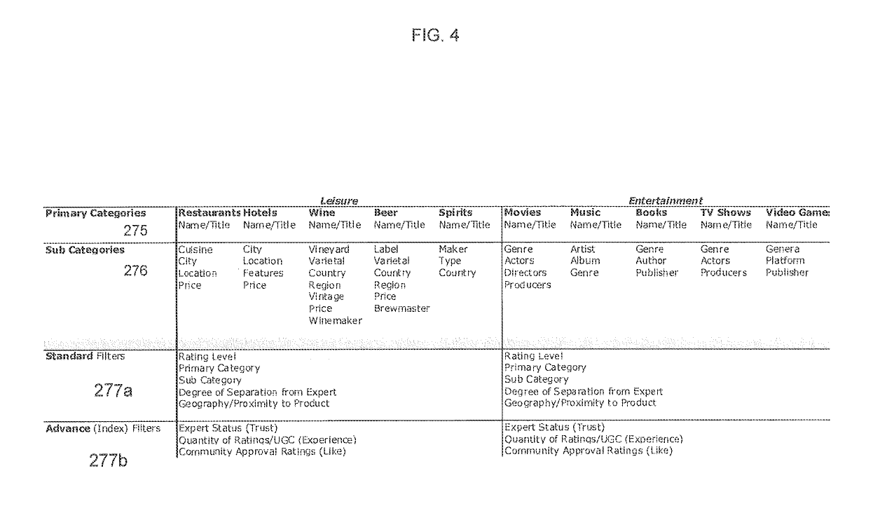

FIG. 4 depicts exemplary categories 275 and sub-categories 276 associated with particular categories with which contacts may be associated. The subcategories provide finer granularity for categorizing. For example, a category may be “wine” and a subcategory may be “varietal” (Cabernet, Merlot, Zinfandel, etc).

Referring back to FIG. 2A, at block 210, TSTLNs of a user are selectively activated/deactivated. In an exemplary embodiment, once TSTLNs are established, the user can individually turn the TSTLNs on (active) and off (inactive) as desired. In one embodiment, trustline processor 120 may present a GUI on user device 102 presenting each contact of the user designated as a TSTLN of the user along with an “active” check box and a “inactive” checkbox. In accordance with this embodiment, the user may selectively designate which TSTLNs are active and which TSTLNs are inactive simply by checking the appropriate check box.

FIG. 5B illustrates the trusted connections between the user and contacts 255x and p turned on, and the trusted connection to expert 255d turned off. In this arrangement, the user is able to retrieve information from TSTLNs 255x and 255p (but not 255d), and from the TSTLNs with which contacts 255x and 255p have active trustline connections (e.g., 255xa, xb, xc and 255pa, pb, pc); and from the active TSTLNs of contacts 255xa, xb, xc and 255pa, pb, pc, etc.

FIG. 5C illustrates the trustline connections between the user and contacts 255x and d turned on and the trusted connection to expert 255p turned off. In this arrangement, the user is able to retrieve information from TSTLNs 255x and 255d (but not 255p), and from the TSTLNs with which contacts 255x and 255d have active trusted connections (e.g., 255xa, xb, da, and db, but not 255xc); and from the active TSTLNs of contacts 255xa, xb, da, and db. In an exemplary embodiment, a contact such as contact 255xc in FIG. 5C may be designated as inactive by the user with which that contact has a trustline information resource connection (e.g., by contact 255x for 255xc).

In an additional embodiment, to improve search results a user requesting the search may designate one or more TSTLNs of their TSTLNs as inactive for purposes of generating search results for queries by that user. For example, a user may designate contact 255xc as inactive if the user does not want results from that contact (e.g., does not trust that contact's recommendations based on past experience). In accordance with this embodiment, designation of a contact as inactive for the user's queries only renders that contact inactive from the user's viewpoint and does not render that contact inactive as a TSTLN of other users (e.g., contact 255xc may remain an active TSTLN of contact 255x for contact 255x and other users unless contact 255x designates contact 255xc as inactive.

The number of active TSTLNs may be limited. In an exemplary embodiment, the number of active TSTLNs is limited to ten or less per category and, more preferably, to five or less. Step 210 may be performed for every user 103 within social network database 122.

FIG. 2B depicts a flow chart 220 of exemplary steps for retrieving information about a category of interest from a social network In accordance with aspect of the present invention. The steps of flow chart 220 will be described with reference to the system 100 depicted in FIG. 1 to facilitate description. Other systems in which the steps of flow chart 220 may be carried out will be understood by one of skill in the art from the description herein.

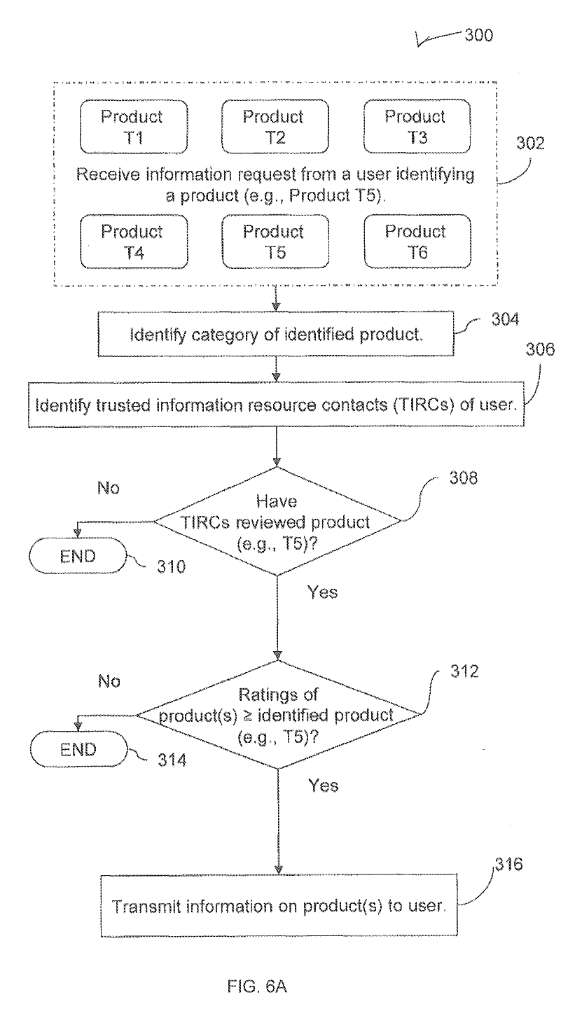

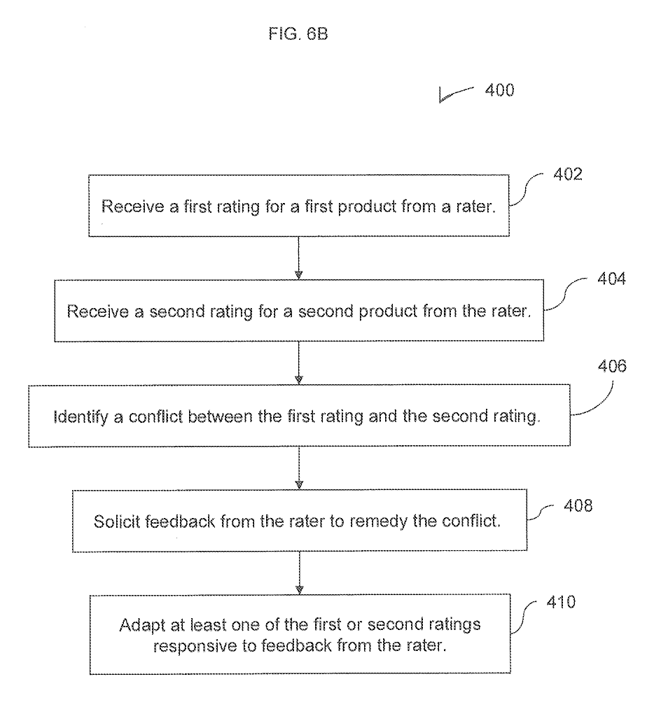

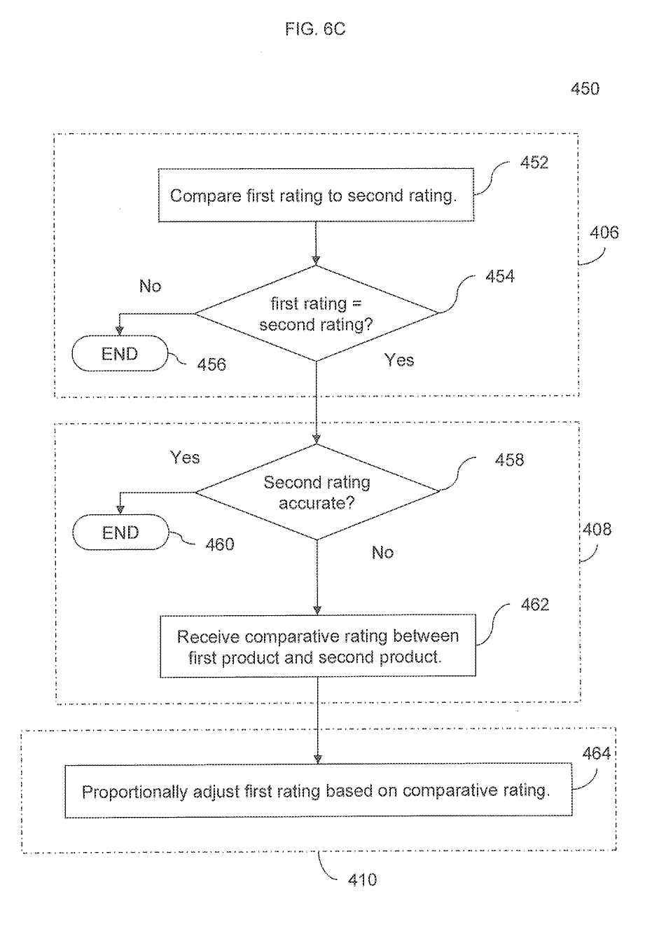

At block 222, an information request is received that specifies a category. In an exemplary embodiment, the host server 104 receives an information request from a user 103. The information request may include content filtering information such as the standard filters 277a and/or advanced filters 277b set forth in FIG. 4. The host server 104 may generate and present a GUI (not shown) to the user 103 for submitting an Information request. The information request GUI may include a series of check boxes associated with various categories/sub-categories and a submit button. In an exemplary embodiment, an information request may be generated by selecting one or more categories/subcategories and selecting the submit button. Additionally, the GUI may include a text box for entering a question for submission to a user's trusted information resources. The GUI may further include check boxes or other means for entering filter information for standard filters 277a and/or advanced filters 277b. The information request may include a request for the Identification of product(s) that a TSTLN has rated higher that a particular product such as described below with reference to FIG. 6A.

At block 224, a first set of users within the user's network are identified that are associated with the category (i.e., contacts 255 in category based network 265) and that are established as TSTLNs for that category (i.e., contacts 255 in set 270). In an exemplary embodiment, the host server 104 identifies the first set of users by examining the social network database 122 based on the category specified in the information request and the user's established TSTLNs for that category. The first set of users may be thought of as “experts” from the viewpoint of the user.

At block 226, a second set of users within the category based networks of the first set of users are identified that are associated with the category and that are designated as TSTLNs for the category by the first set of users. In an exemplary embodiment, the host server 104 identifies the second set of users by examining the social network database 122 based on the category specified in the information request and the TSTLNs established of the first set of users for that category. The second set of users may be thought of as “experts” of the first set of users, e.g., the expert's experts. The steps of block 226 may be repeated to obtain information from TSTLNs that are farther removed from the user, e.g, the expert's expert's expert, the expert's expert's expert's expert, and so on. This may be accomplished by checking if information should be obtained from a level that is farther removed in step 228. If the answer is yes, step 226 is performed again. Otherwise, processing proceeds at block 230.

At block 230, information is retrieved for identified users. In an exemplary embodiment, the host server 104 retrieves information from the database 122 for identified users (e.g., those identified In steps 224 and/or 226) corresponding to the information request. The information may be ratings and/or reviews of products within the selected category (step 222), or answers to questions within the selected category. For example, assume the category is action films. The host server 104 may retrieve all ratings and/or reviews of action films by the TSTLNs identified in steps 224 and/or 226. If a user has a question associated with a category, the information may be retrieved by disseminating the question to the identified users and gathering responses from the identified users.

At block 232, retrieved information is provided to a user. In an exemplary embodiment, information retrieved by the host server 104 from the database 122 at block 230 is transmitted to the client device 102 from which the information request was received (step 222) where it may be viewed by the user 103.

The exemplary steps described above enable a user to monitor new ratings, reviews and other UGC of their TSTLNs within a desired category and the TSTLNs of these TSTLNs, etc.; search ratings, reviews and other UGC of TSTLNs within a desired category and the TSTLNs of these TSTLNs, etc.; and send questions to or communicate directly with TSTLNs within a desired category and to/with the TSTLNs of these TSTLNs, etc. It will be understood by one of skill in the art from the description herein that in embodiments where categories are not assigned, the information request (block 222) will not solicit and Include a category. Furthermore, users will not be identified (blocks 224 and 226) based on the category, but rather by being assigned as trustlines.

Monitoring, searching, and sending functionality is described in further detail below:

Monitoring—user 103 can set personal preferences within the social network to receive information through direct links established through extended category based networks of users identified as TSTLNs within those category based networks. The information from these TSTLNs can include ratings, reviews, links, UGC, etc. Within this mode of functionality the user receives the information automatically. The information can be filtered by criteria such as set forth in standard filters 277a and/or advance filters 277b (FIG. 4) including by way of non-limiting example, the degrees of separation from the TSTLN, the status of active TSTLN designations, the number of UGC posts, ratings or reviews within a specific topic category by each TSTLN, and the social network communities' approval or rating of a TSTLN's UGC, ratings, reviews, etc.

As an example, a user may set their “monitor” preferences to notify them of reviews down to the third degree of separation by TSTLNs within category based networks for a particular category (e.g., Italian restaurants) with a particular rating (e.g., above 9.3).

Searching—user 103 can search for ratings, reviews, user generated content, and published content by keywords, pictures, dimensional barcodes, non-dimensional barcodes, UPC codes, geocode, GPS coordinates, and more, through direct links established through extended category based networks of users identified as TSTLNs within a category. Within this mode of functionality the user actively requests the information. The information can be filtered by criteria such as set forth in standard filters 277a and/or advanced filters 277b (FIG. 2B), including by way of non-limiting example, the degrees of separation from the TSTLN, the status of active TSTLN designations, the number of UGC posts, ratings or reviews within a specific topic category by each TSTLN, and the social network communities' approval or rating of a TSTLN's UGC, ratings, reviews, etc.

As an example, a user may search for ratings, reviews, or other valuable UGC by scanning the barcode on Malcom Gladwell's book “Outliers” in order to receive relevant information from up to the fifth degree of separation within his trusted resource or expert category based network for books.

FIG. 6A depicts a flowchart 300 of exemplary steps for searching existing review or monitoring future reviews in accordance with one aspect of the present invention. At block 302, a information request is received (e.g., at host server 104) from a user identifying a particular product (e.g., product T5 from a group of products including products T1-T6). At block 304, a category/subcategory associated with the identified product is identified. For example, the host server 104 may identify the category/subcategory (e.g., Napa Cabernets) associated with product T5 by comparing a product identifier (e.g., UPC code) for product T5 with entries in a database.

At block 306, TSTLNs of the user for the identified category are identified. In an exemplary embodiment, host server 104 identifies TSTLNs for the identified category as described above for blocks 224 and 226 of flow chart 200.

At block 308, host server 304 determines if the TSTLNs have reviewed the product identified by the user. In an exemplary embodiment, host server 104 compares a product identifier of the identified product to product identifiers of all products reviewed by the TSTLNs. If there is not a match, processing ends at block 310. If there is a match, indicating that one or more of the TSTLNs have reviewed the Identified product, processing proceeds at block 312.

At block 312, host server 304 determines for each TSTLN that has reviewed the identified product whether they rated another product the same or higher than the identified product. If no TSTLN has rated any other products within the category equal to or greater than they rated the identified product, processing ends at block 314. If one or more TSTLNs rated one or more other products equal to or greater than the identified product, processing ends at block 316 with information for those products being transmitted to the user device 102 of the user 103 requesting the information. This process allows a user to quickly and easily identify other products that the user may wish to try because they were rated by the user's expert, expert's expert, and/or expert's expert's expert, as equal to or better than the identified product.

It will be understood by one of skill in the art from the description herein that in embodiments where categories are not assigned, the category identification (block 304) may be omitted. Furthermore, in block 306, all TSTLNs of the user will be identified.

Q&A'ing—user 103 can send questions to be answered through direct links established through extended category based networks of users identified as TSTLNs within a category. Within this mode of functionality the user actively requests answers to questions. The TSTLN can filter questions to answer based on, for example, the degrees of separation from the questioning user. The answers can be filtered by criteria such as set forth in standard filters 277a and advance filters 277b (FIG. 2B), including by way of non-limiting example, the degrees of separation from the TSTLN, the status of active TSTLN designations, the social network communities' approval or rating of a TSTLN's answers, and other indications of credibility or status.

As an example, a user may send a question out to his trusted resource network for wine, “I am going to San Francisco next month. If I have two days in Napa, what wineries should I try to schedule a tasting?”

Another aspect of the present invention relates to an adaptive rating system and method that ensures that ratings of entities (e.g., (product, person, service, experience, etc.) remain relevant for a user as that user's level of experience matures. For example, a user rating a bottle of wine may have a different rating opinion after having rated 50 bottles of wine than after rating three bottles of wine. The present invention enables past and/or new ratings to be automatically adjusted in order to make them more relevant.

FIG. 6B depicts a flow chart 400 of exemplary steps for adapting ratings and FIG. 6C depicts a flow chart 450 of exemplary sub-steps within the steps of flow chart 400. The steps of flow charts 400 and 450 will be described with reference to the system 100 depicted in FIG. 1 to facilitate description. Other suitable systems will be understood by one of ordinary skill in the art from the description herein. As used herein rating may refer to a numerical rating or a relative ranking.

At block 402, a first rating for a first product is received from a user. The rating may be a rating on a scale of 1 to 10 (e.g., a nine) for a product within a category or within a subcategory (e.g., a wine or a California Pinot Noir). In an exemplary embodiment, processor 116 may be coupled to a receiver (not shown) that receives the rating from a user 103 via user device 102 over network 106.

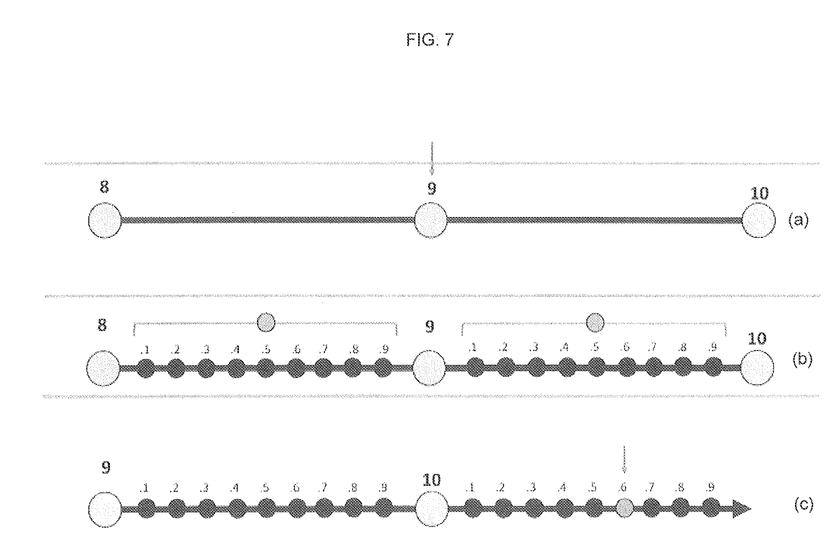

At block 404, a second rating for a second product is received from the user. The rating may be a rating on a scale of 1 to 10 (e.g., a nine) for another product within the category or subcategory (e.g., a wine or a California Pinot Noir). In an exemplary embodiment, processor 116 may be coupled to a receiver (not shown) that receives the rating from the user 103 via user device 102 over network 106. FIG. 7(a) depicts a user attempting to rate a second/new product that same as a first/benchmark product (e.g., as a “9”).

Referring back to FIG. 6B, at block 406, a potential conflict Is identified between the first rating and the second rating. In an exemplary embodiment, processor 116 identifies the potential conflict. FIG. 6C depicts exemplary sub-steps for identifying a potential conflict (step 406). At sub-step 452, processor 116 compares the first rating to the second rating. At sub-step 454, processor 116 determines if the first rating equals the second rating. If the ratings are equal, processor 116 identifies a potential conflict and processing proceeds at block 408. If the ratings are not equal, processing ends at block 456.

At block 408, feedback is solicited from the user to remedy the potential conflict. In an exemplary embodiment, processor 116 solicits feedback to remedy the potential conflict.

FIG. 6C depicts exemplary sub-steps for soliciting feedback to remedy the potential conflict (step 408). At sub-step 456, processor 116 determines if the second rating Is accurate based on the current rating scale for the category. The current rating scale includes at least one rating of a product (e.g., the first rating for the first product). In an exemplary embodiment, processor 116 sends a first inquiry to the user asking if the second rating is accurate based on the current rating scale (e.g., should the second product have the same rating as the first product). If the second rating is inaccurate (e.g., no, the first and second products are not equivalent to the user rating the products, processing proceeds at block 462. If the second rating is accurate (e.g., yes, the first and second products are essentially equivalent to the user rating the products), processing ends at block 460.

At sub-step 462, processor 116 receives a comparative rating between the first product and the second product. In an exemplary embodiment, processor 116 sends a rating scale such as depicted in FIG. 7(b) for display by user device 102 to solicit feedback from user 103. The depicted rating scale provides a number of subintervals in the vicinity of the first product rating for selection by user 103. For example, if the second product is a little better than the first product and the first product has a rating by user 103 of “9”, the user may select a slightly higher rating, e.g., “9.5” on the rating scale. In this case, the comparative rating would be “0.5” better. Similarly, if the second product is a little worse than the first product, the user may select a slightly lower rating, e.g., “8.5” on the rating scale. In this case, the comparative rating would be “0.5” worse, The user may enter the comparative rating in other well known manners, e.g., by typing in a comparative value or other value from which a comparative value may be obtained.

At block 410, the first or second rating is adapted responsive to the feedback solicited from the user. In an exemplary embodiment, processor 116 adapts the first or second rating. FIG. 6C depicts an exemplary sub-step for adapting that rating of the first or second rating (step 410). At step 464, processor 116 proportionally adjusts the first rating based on the comparative rating. In an exemplary embodiment, the rating of a first product is only adjusted when the first product has the maximum value rating on the rating scale (e.g., a value of “10” on a ten-point scale) and a maximum value rating is received for a second product that they user believes should have a higher rating than the first rating.

As an illustrative example, consider a first product having a rating of 10 as previously rated by the user. If the user attempts to rate a second product as a 10, similar to as illustrated in FIG. 7(a), the system (e.g., processor 116) will Identify a conflict. Feedback will then be solicited from the user to determine if the second product should have the same rating as the first product. If the user Indicates that it should not have the same value, the user submits a comparative rating of the second product to the first product, e.g., a rating of 9.1-9.9 or 10.1-10.9. In an exemplary embodiment, if a rating of 10.1 to 10.9 were received from the user (e.g., 10.6 as illustrated in FIG. 7(c)), the second product would then be established as a benchmark for a rating of 10 and the first product (and any other previously rated products for the category) would be proportionally re-rated, e.g., by processor 116. For example, if the first product had a rating of 10 and the second product was given a comparative rating of 10.6, the first product would be given a rating of 9.4 (10.0-0.6=9.4) and the second product would be established as a 10. It will be understood that the system could be applied to many ratings for many products, in which case all the previously rated products may be automatically adjusted in a manner similar to the first product.

For example, as a first step (STEP ONE) ratings may be received by the host server 104 from a user 103 rating multiple products within a category, e.g., product 1=3, product 2=5, and product 3 equal 8. The host server 104 may then proportionally adjust the ratings of the products to a standardized scale in which the rating of the highest rated product is set to the top value of the standardized scale and the ratings of the other products are proportionally adjusted. For example, if the standardized scale is a ten-point scale, product 3 may be set to 10 and products 1 and 2 may be proportionally adjusted, e.g., product 1 equals 4 (3/8*10=3.75) and product 2 equals 6 (5/8*10=6.25). Next (STEP THREE), the host server 104 receives a rating for a product within the category from the user 103 that has a rating higher than the highest rated product within that category, e.g., product 4 equals 10.9. Finally (STEP FOUR), the host server 104 adjusts the new rating to the highest rating and proportionally adjusts the other ratings. For example, product 4 is set equal to 10; product 1 is set equal to 4 (Old Score−Old Score*Adjustment Factor=Old Score−Old Score*(Max benchmark for 10−10)/10=Old Score−Old Score*(10.9-10)/10=4−4*0.09=3.64); products 2 is set equal to 5 (Old Score−Old Score*Adjustment Factor=Old Score−Old Score*(Max benchmark for 10−10)/10=Old Score−Old Score*(10.9−10)/10=6−6*0.09=5.46); and product 3 is set equal to 9 (Old Score−Old Score*Adjustment Factor=Old Score−Old Score*(Max benchmark for 10−10)/10=Old Score−Old Score*(10.9−10)/10=10−10*0.09=9.1),In another embodiment, ratings are proportionally adjusted whenever a potential conflict is identified and a comparative rating (e.g., higher and/or lower) is received from a user.

Aspects of the adaptive rating system may include by way of non-limiting example:

a) A rating system where the entity (product, person, service, experience, etc) with the highest rating serves as the benchmark for which all lower rated products or experiences are ranked against within a specific category.

b) A process that requires the user to rate any new entities in relation to the value of current benchmarks within a specific category.

c) A rating system where a process requires the user, when attempting to rate an entity that has an equal rating to an existing entity, to confirm that the rating of the entity is truly equal, where if the rating of the new entity is not equal, the rating of the new entity has to be set either greater than or less than the previous benchmark for that entity.

d) A process that when the user Indicates that the rating of a new (or rerated) entity is greater than the current highest benchmark, all the rating of entities weighted in relation to the former benchmark are adjusted proportionally.

The present invention is capable of adjusting ratings as a user's tastes mature and experience within a category/subcategory evolves, while keeping scores based on a relative scale. For example, a user tries a mid-tier Bordeaux as one of their first wine experiences and give it a 10. As the user tries other wines they do not enjoy as much they will rate them less than 10 (using the mid-tier Bordeaux as the top of the scale). The user may eventually try a Bordeaux they enjoy more than any other he has previously experienced. When he tries to give it a score of 10, the adaptive rating system/method requires him to rate this Bordeaux in comparison to the mid-tier Bordeaux that is currently serving as his benchmark for “10”. If the user feels they are equal, both remain a 10. If the user rates the new Bordeaux greater than the current standing mid-tier Bordeaux (e.g. 10.5), the 10.5 Bordeaux becomes the new benchmark for “10”. The previous mid-tier Bordeaux that represented 10, along with all the wines that were rated In comparison to the mid-tier Bordeaux are automatically adjusted In relation to the new 10 point scale now established by the 10.5 Bordeaux. By adapting the rating scale (maintaining a TrueIO^{m1} rating system), the value of an individual rating becomes significantly more valuable and relevant to users within a network.

The adapted score makes an expert's ratings or recommendations more relevant, which can be further enhanced by considering additional features, including, but not limited to:

a trust index: how many people directly trust a person as a TSTLN (e.g., expert) for a specific category,

a like index: the degree to which other users “like” the answers, recommendations, and/or ratings of an expert,

an experience index: how many products the expert has rated, questions they have answered, etc.

It is contemplated that one or more of the various components and steps described above may be Implemented through software that configures a server to perform the function of these components and/or steps. This software may be embodied in a non-transient machine readable storage medium, e.g., a magnetic disc, an optical disk, a memory-card, or other tangible medium capable of storing instructions. The instructions, when executed by computer, such as a server, cause the computer to execute a method for performing the function of one or more components and/or steps described above.

Although the invention is illustrated and described herein with reference to specific embodiments, the invention is not intended to be limited to the details shown. Rather, various modifications may be made in the details within the scope and range of equivalents of the claims and without departing from the invention.

We claim:

1. A method of establishing trustlines (TSTLNs) for a user within a social network comprising:
establishing a trust-based network for a user;
establishing TSTLNs within the user's trust-based network; and
associating at least one TSTLN with one or more categories.

2. The method of claim 1, further comprising: selectively activating TSTLNs within the user's trust-based network.

3. The method of claim 2, further comprising: selectively deactivating TSTLNs within the user's trust-based network.

4. The method of claim 1, wherein the associating step is performed after the establishing TSTLNs step.

5. The method of claim 1, wherein the associating step is performed before the establishing TSTLNs step.

6. A method of obtaining information from a computer network, the computer network including a plurality of user networks, each user network Including a plurality of users, the network further including an electronic database of information associated with the plurality of users, the method comprising:
receiving an information request from a user, the Information request specifying a product;
identifying a first set of one or more users within a user network of the user, each user in the first set established as a trustline (TSTLN) of the user and each user in the first set associated with the specified product and a rating of the specified product;
identifying a second set of one or more users within a user network of one or more users of the first set, each user in the second set established as a TSTLN of the one or more users of the first set and each user in the second set associated with the specified product and a rating of the specified product;
retrieving product information from the one or more trusted information resource contacts of the identified second set from the electronic database for at least one product having a rating by at least one of the identified second set that is higher than a rating of the specified product by the at least one of the identified second set; and
providing the retrieved product information to the user.

7. The method of claim 6, wherein the product information comprises a name of the at least one product.

8. The method of claim 6, wherein the rating of the specified product is a numerical rating.

9. The method of claim 6, wherein the rating of the specified product is a ranking relative to at least one other product.

10. A method of establishing trustlines (TSTLNs) for a user within a social network comprising:
establishing a trust-based network for a user; and
establishing TSTLNs within the user's trust-based network.

11. A method of obtaining information from a computer network, the computer network including a plurality of user networks, each user network Including a plurality of users, the network further including an electronic database of information associated with the plurality of users, the method comprising:
receiving an information request from a user, the information request specifying a product;
identifying a first set of one or more users within a user network of the user, each user in the first set established as a trustline (TSTLN) of the user;
identifying a second set of one or more users within a user network of one or more users of the first set, each user in the second set established as a TSTLN of the one or more users of the first set;
retrieving product information from the one or more trusted information resource contacts of the identified second set from the electronic database for the product; and
providing the retrieved product information to the user.

12. A computer-implemented system for generating a plurality of verified subject matter contacts, comprising:
a non-transitory computer readable storage medium having encoded thereon computer executable instructions for providing a graphical user interface for receiving user input associated with at least one category;
at least one network port for remotely accessing via a network at least one server wherein at least one TIRC-associated code is resident; and
at least one rules engine communicatively connected to said at least one network port, comprising a plurality of rules to generate at least one recommendations rating associated with the at least one TIRC correspondent to the user input; and
at least one database for storing information related to at least one product retrieved correspondent to the at least one category and at least one recommendations rating;
wherein a user may be associated with one of the at least one TIRC based upon the user input.
